(19) United States
(12) Patent Application Publication
(10) Pub. No.: US 2026/0106488 A1
(43) Pub. Date: Apr. 16, 2026

(54) MODULAR AND SCALABLE CONTROL SYSTEM FOR LOCAL AND/OR REMOTE MANAGEMENT OF A PLANT

(71) Applicant: WÄRTSILÄ FINLAND OY, Vaasa (FI)

(72) Inventors: Göran BLOMQVIST, Vaasa (FI); Joakim KULLAS, Vaasa (FI); Martin BJÖRKLUND, Vaasa (FI); Davide LAMPARELLI, Vaasa (FI)

(73) Assignee: WÄRTSILÄ FINLAND OY, Vaasa (FI)

(21) Appl. No.: 19/114,612

(22) PCT Filed: Sep. 30, 2022
(86) PCT No.: PCT/FI2022/050654

§ 371 Date: Mar. 24, 2025

(51) Int. Cl. H02J 13/12; H02J 3/28; H02J 3/38; H02J 13/10; H02J 13/16; H02J 13/181; H02J 101/10; H02J 101/22; H02J 101/28; H02J 101/40

(52) U.S. Cl. CPC H02J 13/12; H02J 3/28; H02J 3/381; H02J 13/10; H02J 13/16; H02J 13/181; H02J 2101/10; H02J 2101/22; H02J 2101/28; H02J 2101/40

(57) ABSTRACT

A system is disclosed for monitoring a modular electrical power plant, the modular electrical power plant including at least two power generation units and an auxiliary system. The system for monitoring a modular electrical power plant includes a plurality of data collection channels for receiving data describing operating conditions of the at least two power generation units and a processing unit configured to generate a user interface. The user interface includes a single power generation unit view and a multiple power generation unit view. The processing unit is configured to select between the single power generation unit view and multiple power generation unit view based on the data describing the operating conditions of the at least two power generation units.

### FIELD OF THE INVENTION

The invention relates to the field of a modular electrical power plant monitoring and control systems.

### BACKGROUND

Power plant monitoring and control systems are used to monitor the operating conditions and control the operation of an electrical power plant. Historically, power plant infrastructure has been large and static and control systems have been built for a specific powerplant based on the specific power plant infrastructure, e.g. the number of engines or turbines. There is a need for a power plant control system that can adapt to a modular power plant, i.e. to changing power plant infrastructure, as well as providing for centralised, remote monitoring and control.

### SUMMARY

According to a first aspect of the invention, a system for monitoring and controlling a modular electrical power plant is provided. The modular electrical power plant comprises at least two power generation units and at least one auxiliary system, and the system comprises:
a plurality of data collection channels for receiving data describing operating conditions of the at least two power generation units and the at least one auxiliary system; and
a processing unit configured to generate a user interface, the user interface comprising a single power generation unit view and a multiple power generation unit view, wherein the processing unit is configured to select between the single power generation unit view and multiple power generation unit view based on the data describing the operating conditions of the at least two power generation units.

The single power generation unit view may comprise operating conditions of a selected one of the at least two power generation units and control elements for the selected one of the at least two power generation units.

The processing unit may be further configured to calculate one or more shared metrics based on the operating conditions of two or more connected power generation units and the multiple power generation unit view may comprise operating conditions of the two or more connected power generation units and the shared metrics.

The user interface may further comprise operating conditions of the auxiliary system.

The modular electrical power plant may further comprise at least one energy storage system, a secondary source of electrical energy, such as a wind turbine or solar panels; and/or the modular electrical power plant may be connected one or more electrical grids. The user interface may further comprise a plant-level view, and the processing unit may be configured to select between the single power generation unit view, multiple power generation unit view and plant-level view based on the data describing the operating conditions of the at least two power generation units and the energy storage system, secondary source of electrical energy and/or one or more electrical grids.

The processing unit may be further configured to calculate one or more plant-level metrics based on the operating conditions of all of the power generation units and the plant-level view may comprise the plant-level metrics.

The plurality of data collection channels may be further configured to receive data describing operating conditions of a connected power grid, and the plant-level view may comprise the operating conditions of the connected power grid.

The plurality of data collection channels may be further configured to receive data describing operating conditions of a connected energy storage system, and the plant-level view may comprise the operating conditions of the energy storage system.

The processing unit may be configured to determine warning conditions based on the received data describing operating conditions and to select a view based on the determined warning conditions.

The processing unit may be configured to select the single power generation unit view when a warning condition relating to a single power generation unit is determined.

The processing unit may be configured to select the multiple power generation unit view when a warning condition relating to multiple connected power generations units is determined.

The processing unit may be further configured to select a view based on user input received by the system such that a user-selected view indicated by the user input is displayed until a warning condition is determined.

The user interface may be configured to adapt to the number of power generation units, the presence of auxiliary systems, and the presence of external connected systems by enabling or disabling user interface views or modifying the content of the user interface views to reflect the number of power generation units, the presence of auxiliary systems or the presence of external connected systems.

The at least one auxiliary system may comprise equipment for controlling the operation of one or more connected power generation units, optionally including one or more of a pre-lubrication pump, a turbo washing unit and an oil mist separator.

Each power generation unit may comprise an internal combustion engine and a generator.

The system may further comprise a display configured to display the generated user interface.

The processing unit may be further configured to transmit the user interface to a remote computing device such that the user interface is displayed on the remote computing device or a display attached to the remote computing device.

The processing unit may be further configured to receive control input via the user interface and to transmit control signals to one or more of the at least two power generation units and an auxiliary system in response to the control input.

The power plant may comprise at least five power generation units, or at least ten power generation units.

The power generation units may be arranged into one or more sets of power generation units such that each power generation unit in a set of power generation units is connected to the same auxiliary system.

The power plant may be connected to an external electrical grid, and the system may be configured to send control to the power generation units that cause the power plant to begin generating power and begin supplying energy to the external electrical grid in three minutes or less, preferably in 30 seconds or less.

The system may be configured to send control signals to the power generation units that cause the load level of the power generation units to increase to 95% from an idle state or an off state in five minutes or less, preferably in two minutes or less.

According to a second aspect of the invention, a computer-implemented method for monitoring and controlling operation of a modular electrical power plant is provided. The modular electrical power plant comprises at least two power generation units and at least one auxiliary system, and the method comprising:
receiving data describing operating conditions of the at least two power generation units and the at least one auxiliary system via a plurality of data collection channels;
generating, with a processing unit, a user interface, the user interface comprising a single power generation unit view and a multiple power generation unit view; and
automatically selecting the single power generation unit view or multiple power generation unit view based on the data describing the operating conditions of the at least two power generation units.

The single power generation unit view may comprise operating conditions of a selected one of the at least two power generation units and control elements for the selected one of the at least two power generation units.

The method may further comprise:
calculating, with the processing unit, one or more shared metrics based on the operating conditions of two or more connected power generation units; and
outputting the shared metrics and operating conditions of the two or more connected power generation units in the multiple power generation unit view.

The user interface may further comprise operating conditions of the auxiliary system.

The modular electrical power plant may further comprise at least one energy storage system and/or a secondary source of electrical energy, such as a wind turbine or solar panels, and/or the modular electrical power plant may be connected one or more electrical grids. The user interface may further comprise a plant-level view, and the method may further comprise automatically selecting between the single power generation unit view, multiple power generation unit view and plant-level view based on the data describing the operating conditions of the at least two power generation units and the energy storage system, secondary source of electrical energy and/or one or more electrical grids.

The method may further comprise calculating one or more plant-level metrics based on the operating conditions of all of the power generation units and outputting the plant level metrics in the plant-level view.

The plant-level view may comprise the operating conditions of the energy storage system, secondary source of electrical energy and/or connected power grid.

The method may further comprise determining, with the processing unit, one or more warning conditions based on the received data describing operating conditions and select a user interface view based on the determined warning conditions.

The method may further comprise selecting the single power generation unit view when a warning condition relating to a single power generation unit is determined.

The method may further comprise selecting the multiple power generation unit view when a warning condition relating to multiple connected power generations units is determined.

The method may comprise selecting a view based on user input received by the system such that a user-selected view indicated by the user input is displayed until a warning condition is determined.

The method may comprise automatically adapting the user interface views based on the number of power generation units, the presence of auxiliary systems, and the presence of external connected systems by enabling or disabling user interface views or modifying the content of the user interface views to reflect the number of power generation units, the presence of auxiliary systems or the presence of external connected systems.

The method may further comprise displaying the generated user interface on a display

The method may further comprise transmitting the user interface to a remote computing device such that the user interface is displayed on the remote computing device or a display attached to the remote computing device.

The method may further comprise receiving control input via the user interface and transmitting control signals to one or more of the at least two power generation units and an auxiliary system in response to the control input.

The power plant may comprise at least five power generation units or at least ten power generation units.

The power generation units may be arranged into one or more sets of power generation units such that each power generation unit is a set of power generation units is connected to the same auxiliary system.

The power plant may be connected to an external electrical grid, and the method may further comprise sending control signals to the power generation units that cause the power plant to begin generating power and begin supplying energy to the external electrical grid in three minutes or less, preferably in 30 seconds or less.

The method may further comprise sending control signals to the power generation units that cause the load level of the power generation units to increase to 95% from an idle state or an off state in five minutes or less, preferably in two minutes or less.

According to a third aspect of the invention, a computer readable medium is provided. The computer readable medium comprises instructions which, when executed by a processing unit, cause the processing unit to perform the method set out above.

According to a fourth aspect of the invention, a computer program is provided. The computer program comprises instructions which, when executed by a processing unit, cause the processing unit to perform the method set out above.

### BRIEF DESCRIPTION OF THE DRAWINGS

FIG. 1 is a schematic of a system for monitoring a modular electrical power plant according to the present invention and an exemplary modular power plant.

FIG. 2A shows a power generation unit and auxiliary system.

FIG. 2B shows a single power generation unit view of the user interface.

FIG. 3A shows a modular electrical power plant including multiple power generation units.

FIG. 3B shows a multiple power generation unit view of the user interface.

FIG. 4A shows a complex modular electrical power plant including multiple power generation units and multiple auxiliary systems.

FIG. 4B shows a plant-level view of the user interface.

### DETAILED DESCRIPTION

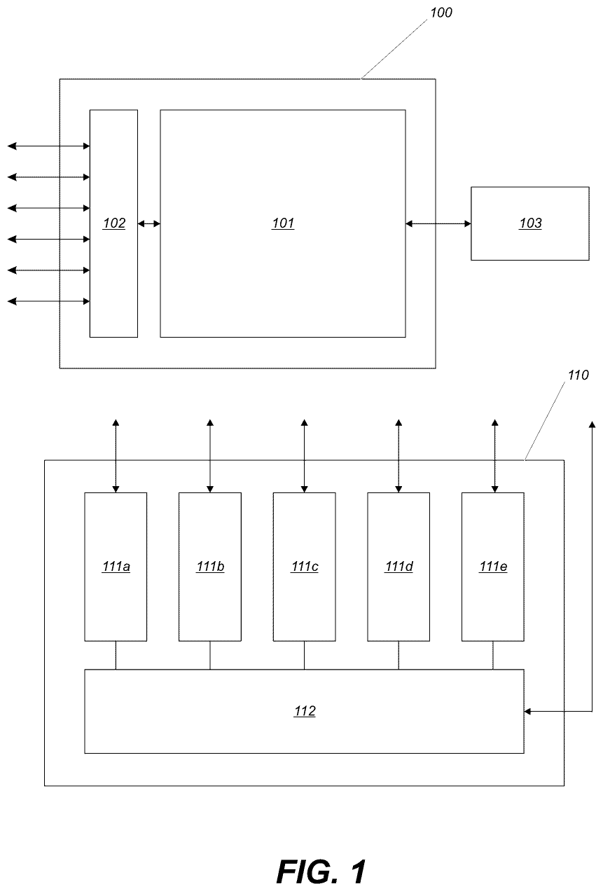

FIG. 1 is a schematic of a system 100 for monitoring a modular electrical power plant according to the present invention and an exemplary modular power plant 110. The system 100 includes a processing unit 101 and a data interface 102 connected to the processing unit 101. The system 100 optionally includes a display device 103. Alternatively, the system 100 may be connected via a network, such as the internet, to a remote system with a display device (not shown). The system 100 is connected via the data interface 102 to a modular electrical power plant 110. The connection may be local, in other words essentially direct, i.e. without an intermediate network such as the internet, or may be a remote connection via an external network such as the internet. The modular electrical power plant 110 shown in FIG. 1 will be understood to be an example of the arrangement of elements of a modular power plant system which, by its modular nature, may include more or less of some of the elements or be arranged in a different way, as described more below. The exemplary modular electrical power plant 110 includes five power generation units 111a-e which are each connected to an auxiliary system 112, which includes multiple smaller support systems, such as cooling systems, air compressors, pre-lubrication pumps, turbo washing units and oil mist separators. Each of the modular elements of the power plant 110 is connected to the control system 100 via the data interface 102. Each element may have its own connection, as illustrated in FIG. 1, or the power generation units may be connected to the control system 100 via the auxiliary system 112, for example. Any suitable communication arrangement may be used as long as it allows data to be transferred between the modular elements of the power plant 110 and the control system 100. Where the modular electrical power plant includes other sub-systems, such as energy storage systems, secondary power generation systems like solar panels or wind turbines, and/or where the modular electrical power plant is connected to an external electrical grid, the system 100 may also receive information regarding the operating characteristics of these subsystems or other connected systems via the data interface 102.

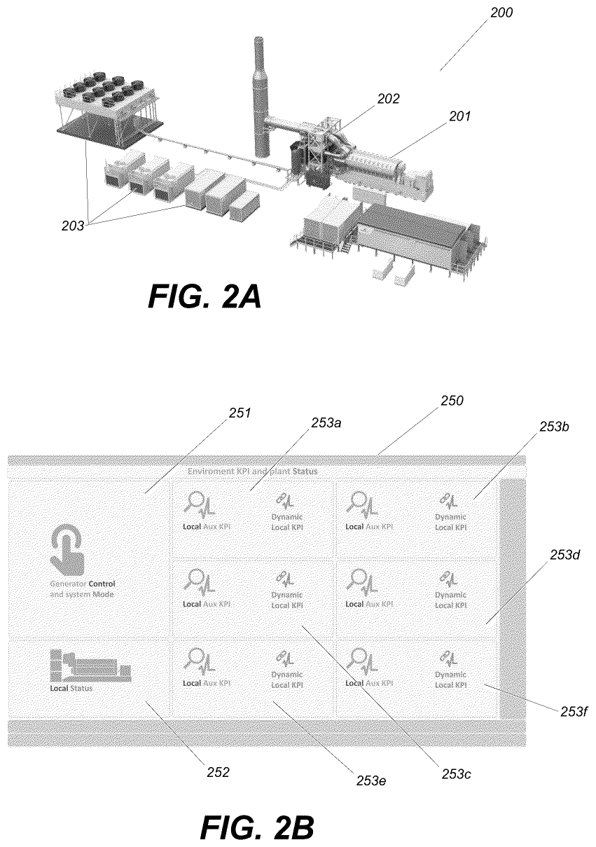

The processing unit 101 is configured to generate a user interface depending on the configuration of the modular electrical power plant and its operating conditions. The user interface and different view thereof are described in more detail in FIGS. 2A to 4B, along with exemplary depictions of modular electrical power plants and elements for which the system may be used.

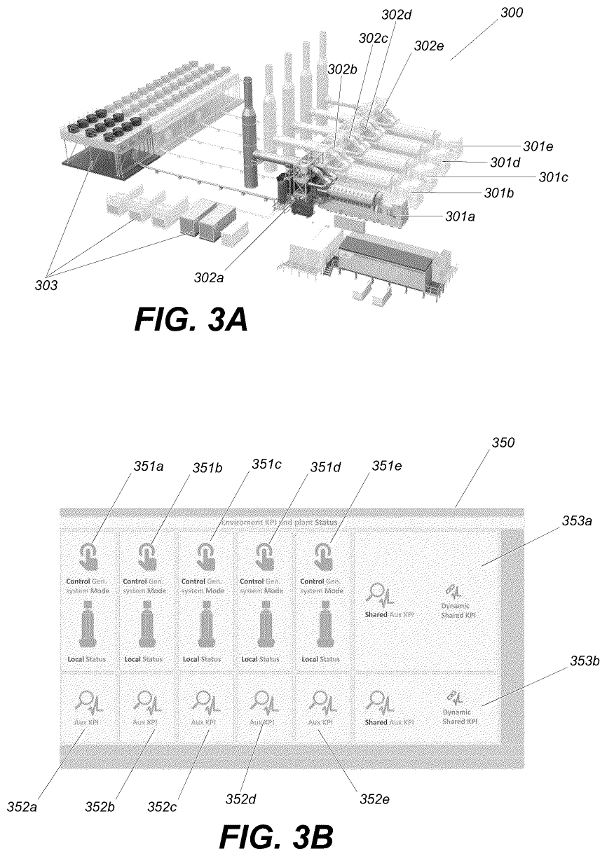

FIG. 2A shows an exemplary power generation unit 200 that may be used as part of the system and method of the present invention. The power generation unit 200, which may correspond to one of the power generation units 111a-e shown in FIG. 1, includes an engine 201, such as an internal combustion engine, and a generator 202, connected to the engine 201 and configured to convert the mechanical energy produced by the engine 201 into electrical energy. The combination of an engine 201 and a generator 202 is used in one particular embodiment and is advantageous because it allows relatively fast turn-on of the power generation unit compared to a thermal system employing turbine generators, for example. However, it is not essential that the power generation unit 200 is made up of an engine 201 and generator 202. The control system of the present invention may be used with any type of power generation unit capable of electronic monitoring and control. The power generation system shown in FIG. 2A may also comprise an auxiliary system 203. The auxiliary system 203 may also be connected to additional power generation units 200, as shown in FIG. 3A.

FIG. 2B shows a single power generation unit view 250 of a user interface of the present invention. The single power generation unit view 250 includes a generator control section 251, a generator status section 252, and multiple auxiliary system status sections 253a-f. The single power generation unit view 250 provides the operator of the system with information describing the operating conditions of the power generation unit 200 and an auxiliary system 203 that it is connected to. A different single power generation unit view 250 is generated for each power generation unit in the system, showing the operation information describing the operating conditions of that specific power generation unit 200, for example in the generator status section 202. However, the auxiliary system status sections 253a-f may be the same for multiple power generation units 200 when they are connected to the same auxiliary system. The single power generation unit view 250 may also provide control inputs related to the specific power generation unit, for example in generator control section 251. These controls may include essential controls such as “turn on”, “turn off” and “idle”, which when used trigger a chain of automated control commands that are provided to the power generation unit 200. It will be appreciated that the precise layout of elements 251, 252 and 253a-f shown in FIG. 2B is exemplary and it is the type and technical content of the information that is provided to the operator that is essential to the invention, not the precise way in which it is displayed. In this way, the single power generation unit view 250 provides a concise and easily understandable overview of the operating conditions of a single power generation unit 200 and the auxiliary system 203 to which it is connected.

FIG. 3A shows an exemplary modular power plant 300 including five power generation units, each made up of an engine 301a-e and generator 302a-e. The power generation units are each be the same as the power generation unit shown in FIG. 2A. The power plant also includes an auxiliary system 303, which is the same as the auxiliary system 203 described above with respect to FIG. 2A.

FIG. 3B shows a multiple power generation unit view 350 of the user interface of the present invention. The multiple power generation unit view 350 includes single power generation unit sections 351a-e corresponding to each of the power generation units present in the modular power plant, e.g. the five power generation units shown in FIG. 3A. Single power generation unit sections 351a-e may also include control inputs for the corresponding power generation unit, as described above with respect to the generator control section 251 shown in FIG. 2B. The controls available in single power generation unit sections 351a-e may be a reduced set of controls compared to those available in the control section 251 of the single power generation unit view 250. The multiple power generation unit view 350 may also include shared metrics sections (not shown) in which metrics calculated by the processing unit 101 from the operating characteristics of multiple power generation units, such as combined power output, may be displayed.

Individual auxiliary system information sections 352a-e contain information related to the parts of the auxiliary system specific to each power generation unit, e.g. the parts of the cooling system linked to each power generation unit. Shared auxiliary system information sections 353a-b contain information related to the parts of the auxiliary system shared between power generation units.

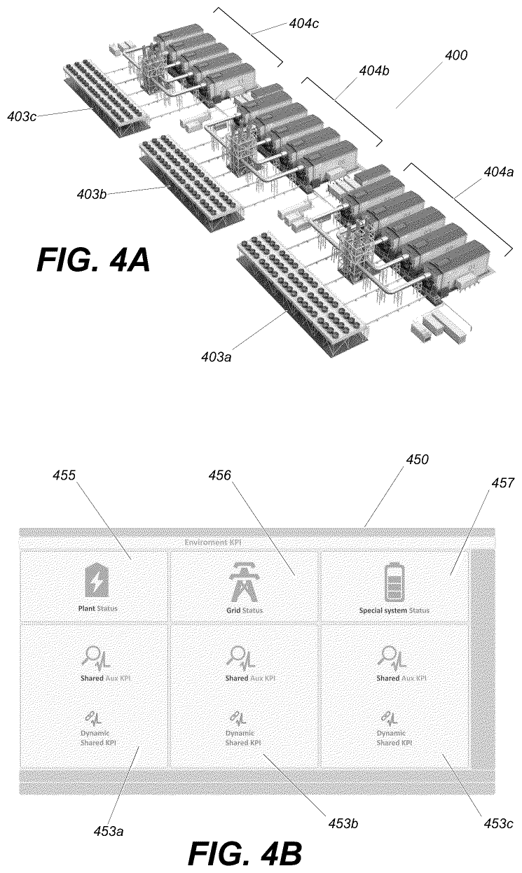

FIG. 4A shows an exemplary modular power plant 400 including multiple sets of power generation units 404a-c, each of which is connected to a different auxiliary system 403a-c. Each set of power generation units corresponds to the modular power plant 300 shown in FIG. 3A. The modular power plant 400 may also include one or both of an energy storage system, for example a battery-based energy storage system, and a secondary source of energy, such as wind turbines or solar panels, and may also be connected to an external electrical grid. In this way, the modular power plant 400 may be used for grid frequency or load balancing. While energy storage, secondary energy sources and grid connections have been described in the context of a complex modular power plant as shown in FIG. 4A, it will be appreciated that they may also be present in a simpler modular power plant, such as that shown in FIG. 3A. In some power plants with which the present invention is used, the system comprises 5, 10, 15 or 20 power generation units. The power generations units are grouped into sets of power generation units, where each power generation unit in a given set is connected to the same auxiliary system.

FIG. 4B shows an exemplary plant-level view 450 of the user interface of the present invention. The plant-level view 450 includes a plant status section 455, grid status section 456, storage system status section 457, and auxiliary system status sections 453a-c. Plant status section 455 provides an overview of the operating conditions of the plant, for example current power generation, number of power generation units online etc. Grid status section 456 is shown if the power plant is connected to an external electric grid and show operating characteristics of the grid, such as the current grid frequency. Storage status section 457 is shown if the power plant includes an energy storage system and shows operating conditions and properties of the storage system, for example energy storage capacity, and energy storage charging/discharging rate. If the power plant includes secondary power generation system, such as wind or solar power, then operating characteristics of the secondary power generation system are also shown in the plant level view. Auxiliary system status sections 453a to 453c show the operating conditions and characteristics of the auxiliary systems in use in the power plant. For each auxiliary system in the power plant, a separate auxiliary system status section 453a to 453c may be included in the user interface and may be the same as the shared auxiliary system information sections described above with respect FIG. 3B. The plant-level view 450 may also include a plant-level metrics sections (not shown) in which metrics calculated by the processing unit 101 from the operating characteristics of multiple power generation units, multiple sets of power generation units or all power generation units, may be displayed, such as combined power output of all power generation units in the power plant.

The processing unit 101 is configured to select between the single power generation unit view and multiple power generation unit view based on the data describing the operating conditions of the at least two power generation units. In one aspect, the processing unit 101 determines warning conditions based on the received data describing operating conditions of the modular power plant and the elements thereof and may select a view based on the determined warning conditions. As an example, the processing unit may determine a warning condition related to a specific engine 201 in a power generation unit and automatically select the single power generation unit view 250 in order to make the relevant information and controls immediately available to a power plant operator. Similarly, the processing unit may determine a warning condition relating to multiple power generation units, for example due a problem caused by a common auxiliary system, in which case the processor selects the multiple generation unit view 350. In the event that the processor determines a plant-level warning condition, or a warning condition in a storage subsystem, secondary power generation system, or external grid, then the processor selects the plant-level view. In this way, the time required for the warning to be recognised and dealt with is decreased, which in turn reduces the chances of damage to any part of the power plant and reduces disruptions caused by abnormal conditions. This is particularly important in the context of a grid balancing power plant that is used to balance the variable power supply obtained from renewable sources such as solar and wind power on an electrical grid. The use of the system and method of the present invention allows for faster response times in the power plant compared to a system using the same engine types because the power plant can be more reliably maintained in a suitable state to quickly begin power generation. Using the monitoring and control system and method of the present invention, the power plant can begin generating power and supplying energy to an external electrical grid in three minutes or less, or 30 seconds or less. The power generation units in the power plant can reach 95% load from an idle state or an off state in five minutes or less, or in two minutes or less. Where even faster response times are required, the power plant may include an energy storage system, such as a battery farm, to bridge the gap between the start of the need for energy supply to the grid and the start of power generation and supply by the power generation units.

The user interface view may also be selected by an operator of the system, either to override a view selected due to a warning condition, or to change the view when no warning conditions are present. The user may navigate from the plant-level view 450 to multiple power generation unit view 350 by selecting, via the user interface, any of the auxiliary system status sections 453a-c or the plant status section. Such selection may take the form of touch input via a touch screen, for example, or clicking with a mouse. The user may navigate between different multiple power generation unit views 350, i.e. between different sets of power generation units and their coupled auxiliary systems. The user may navigate from the multiple power generation unit view 350 to the single power generation unit view 250 by, for example, selecting one of the power generation unit sections 351a-e. The user may navigate up a level, i.e. from the single power generation unit view 250 to the multiple power generation unit view 350, or from the multiple power generation unit view 350 to the plant-level view 450 by selecting a specific object in the user interface. When a warning condition is detected, as described above, the user interface view selected by the user may be automatically overridden, or an alert may appear within the user interface, providing the user with the option to navigate to the user interface view relevant to the warning condition.

The user interface may be further configured to automatically adapt to changes in the modular elements of the modular power plant, e.g. to the addition or removal of power generation units or auxiliary systems, or the connection of energy storage or secondary power generation sub systems. As explained above, the user interface may include plant-level view 450, which provides information and controls related to connected systems such as an external power grid, energy storage systems and secondary power generation systems such as solar or wind. When none of these external connected systems are present, the user interface disables or remove the plant-level view 450, and when one of these systems is subsequently connected, the user interface may create or enable the plant-level view 450. Furthermore, the user interface views 250, 350, 450 themselves may adapt to changing numbers of power generation units, auxiliary systems and externally connected systems. For example, as more power generation units are added and connected to a common auxiliary system, the multiple user interface view 350 is updated to include the additional power generation units in the same view as existing ones.

The invention also includes a method of monitoring and controlling operation of a modular electrical power plant. The method is depicted in FIG. 5.

1.-45. (canceled)

46. A monitoring system for monitoring a modular electrical power plant, the modular electrical power plant including at least two power generation units and at least one auxiliary system, the system comprising:
a plurality of data collection channels for receiving data describing operating conditions of at least two power generation units and at least one auxiliary system; and
a processing unit configured to generate a user interface, the user interface including a single power generation unit view and a multiple power generation unit view, wherein the processing unit is configured to select between the single power generation unit view and multiple power generation unit view based on the data describing the operating conditions of at least two power generation units.

47. The monitoring system of claim 46, wherein the single power generation unit view comprises:
operating conditions of a selected one of the at least two power generation units, and control elements for the selected one of the at least two power generation units.

48. The monitoring system of claim 46, wherein the processing unit is configured to calculate one or more shared metrics based on the operating conditions of two or more connected power generation units, and wherein the multiple power generation unit view comprises:
operating conditions of two or more connected power generation units and the shared metrics.

49. The monitoring system of claim 48, wherein the user interface comprises:
operating conditions of an auxiliary system.

50. The monitoring system of claim 46, in connection with a modular electrical power plant comprising:
at least one energy storage system;
a secondary source of electrical energy, and/or a wind turbine or solar panels; and/or
the modular electrical power plant is connected to one or more electrical grids; and
wherein the user interface includes:
a plant-level view; and
wherein the processing unit is configured to select between the single power generation unit view, the multiple power generation unit view, and the plant-level view based on the data describing the operating conditions of the at least two power generation units and the energy storage system, secondary source of electrical energy, and/or one or more electrical grids.

51. The monitoring system of claim 50, wherein the processing unit is configured to calculate one or more plant-level metrics based on the operating conditions of all power generation units of the modular electric power plant, and wherein the plant-level view comprises:
the plant-level metrics.

52. The monitoring system of claim 50, wherein the plurality of data collection channels is configured to receive data describing operating conditions of a connected power grid, and wherein the plant-level view comprises:
the operating conditions of the connected power grid.

53. The monitoring system of claim 50, wherein the plurality of data collection channels is configured to receive data describing operating conditions of the energy storage system, and wherein the plant-level view comprises:
the operating conditions of the energy storage system.

54. The monitoring system of claim 46, wherein the processing unit is configured to determine warning conditions based on the data describing operating conditions, and to select a view based on the warning conditions.

55. The monitoring system of claim 54, wherein the processing unit is configured to select the single power generation unit view when a warning condition relating to a single power generation unit is determined.

56. The monitoring system of claim 54, wherein the processing unit is configured to select the multiple power generation unit view when a warning condition relating to multiple connected power generations units is determined.

57. The monitoring system of claim 54, wherein the processing unit is configured to select a view based on user input received by the monitoring system such that a user-selected view indicated by the user input is displayed until a warning condition is determined.

58. The monitoring system of claim 46, wherein the user interface is configured to adapt to a number of the power generation units, a presence of auxiliary systems, and a presence of external connected systems by enabling or disabling user interface views or modifying the content of the user interface views to reflect the number of power generation units, the presence of auxiliary systems or the presence of external connected systems.

59. The monitoring system of claim 46, in combination with at least one auxiliary system which comprises:
equipment for controlling operation of one or more connected power generation units, optionally including one or more of a pre-lubrication pump, a turbo washing unit and an oil mist separator.

60. The monitoring system of claim 46, in combination with power generation units which each comprise:
an internal combustion engine and a generator.

61. The monitoring system of claim 46, comprising:
a display configured to display the generated user interface.

62. The monitoring system of claim 46, wherein the processing unit is configured to transmit the user interface to a remote computing device such that the user interface is displayed on the remote computing device or a display attached to the remote computing device.

63. The monitoring system of claim 46, wherein the processing unit is configured to receive control input via the user interface, and to transmit control signals to one or more of the at least two power generation units and an auxiliary system in response to the control input.

64. The monitoring system of claim 46, in combination with a power plant which comprises:
at least five power generation units.

65. The monitoring system of claim 46, in combination with a power plant which comprises:
at least ten power generation units.

66. The monitoring system of claim 46, in combination with power generation units which are arranged into one or more sets of power generation units and wherein each power generation unit in a set of power generation units is connected to a same auxiliary system.

67. The monitoring system of claim 46, in combination with a power plant which is connected to an external electrical grid, and wherein the system is configured to send control to the power generation units that will cause the power plant to begin generating power and begin supplying energy to an external electrical grid in three minutes or less, and/or in 30 seconds or less.

68. The monitoring system of claim 46, wherein the monitoring system is configured to send control signals to power generation units that will cause a load level of the power generation units to increase to 95% from an idle state or an off state in five minutes or less, and/or in two minutes or less.

69. A computer-implemented method for monitoring and controlling operation of a modular electrical power plant, the modular electrical power plant including at least two power generation units and at least one auxiliary system, the method comprising:
receiving data describing operating conditions of the at least two power generation units and the at least one auxiliary system via a plurality of data collection channels;
generating, with a processing unit, a user interface, the user interface including a single power generation unit view and a multiple power generation unit view; and
automatically selecting the single power generation unit view or multiple power generation unit view based on the data describing the operating conditions of the at least two power generation units.

70. The method of claim 69, wherein the single power generation unit view comprises:
operating conditions of a selected one of the at least two power generation units, and control elements for the selected one of the at least two power generation units.

71. The method of claim 69, comprising:
calculating, with the processing unit, one or more shared metrics based on the operating conditions of two or more connected power generation units; and
outputting the shared metrics and operating conditions of the two or more connected power generation units in the multiple power generation unit view.

72. The method of claim 69, wherein the user interface comprises:
operating conditions of the auxiliary system.

73. The method of claim 69, wherein the modular electrical power plant includes:
at least one energy storage system;
a secondary source of electrical energy, and/or a wind turbine or solar panels; and/or
the modular electrical power plant is connected one or more electrical grids; and
wherein the user interface includes a plant-level view, and wherein the method comprises:
automatically selecting between the single power generation unit view, multiple power generation unit view, and plant-level view based on the data describing the operating conditions of the at least two power generation units and the energy storage system, secondary source of electrical energy, and/or one or more electrical grids.

74. The method of claim 73, comprising:
calculating one or more plant-level metrics based on the operating conditions of all of the power generation units, and outputting the plant level metrics in the plant-level view.

75. The method of claim 73, wherein the plant-level view comprises:
the operating conditions of the energy storage system, secondary source of electrical energy, and/or connected power grid.

76. The method of claim 70, comprising:
determining, with the processing unit, one or more warning conditions based on the data describing operating conditions, and selecting a user interface view based on the warning conditions.

77. The method of claim 76, comprising:
selecting the single power generation unit view when a warning condition relating to a single power generation unit is determined.

78. The method of claim 76, comprising:
selecting the multiple power generation unit view when a warning condition relating to multiple connected power generations units is determined.

79. The method of claim 76, comprising:
selecting a view based on user input received such that a user-selected view indicated by the user input is displayed until a warning condition is determined.

80. The method of claim 69, comprising:
automatically adapting the user interface views based on a number of power generation units, a presence of auxiliary systems, and a presence of external connected systems by enabling or disabling user interface views or modifying content of the user interface views to reflect the number of power generation units, the presence of auxiliary systems, or the presence of external connected systems.

81. The method of claim 69, comprising:
displaying the generated user interface on a display

82. The method of claim 69, comprising:
transmitting the user interface to a remote computing device such that the user interface is displayed on the remote computing device or a display attached to the remote computing device.

83. The method of claim 69, comprising:
receiving control input via the user interface, and transmitting control signals to one or more of the at least two power generation units and an auxiliary system in response to the control input.

84. The method of claim 69, wherein the power plant comprises:
at least five power generation units.

85. The system of claim 46, wherein the power plant comprises:
at least ten power generation units.

86. The system of claim 46, wherein the power generation units are arranged into one or more sets of power generation units, and wherein each power generation unit in a set of power generation units is connected to a same auxiliary system.

87. The system of claim 46, wherein the power plant is connected to an external electrical grid, and wherein the method comprises:
sending control signals to the power generation units that will cause the power plant to begin generating power and begin supplying energy to the external electrical grid in three minutes or less, and/or in 30 seconds or less.

88. The system of claim 46, comprising:
sending control signals to the power generation units that will cause a load level of the power generation units to increase to 95% from an idle state or an off state in five minutes or less, and/or in two minutes or less.

89. A non-trajectory computer readable medium comprising instructions which, when executed by a processing unit will cause the processing unit to perform the steps of claim 69.

90. A computer program comprising instructions which, when executed by a processing unit will cause the processing unit to perform the steps of claim 69.
